(19) United States
(12) Patent Application Publication
(10) Pub. No.: US 2013/0197945 A1
(43) Pub. Date: Aug. 1, 2013

(54) e-Sure Insurance Quick Verification System

(71) Applicant: Theodric Anderson, Aurora, CO (US)

(72) Inventor: Theodric Anderson, Aurora, CO (US)

(21) Appl. No.: 13/528,916

(22) Filed: Aug. 28, 2012

(51) Int. Cl. G06Q 40/08

(52) U.S. Cl. CPC G06Q 40/08
USPC 705/4

(57) ABSTRACT

System and method for providing instant access to information about a vehicles insurance coverage. The linking element physically located on the vehicle body which includes vehicle license plate, or can be installed on vehicle for the specific purpose of retrieving insurance information. Linking element can be, radio frequency identification (RFID) or barcode, or quick response code (QRC) affixed anywhere on vehicle. Authorized users immediately access and retrieve current vehicle insurance coverage from a plurality of information retrieval systems including portable and fixed scanning systems, smart phone or other portable devices based on the linking element. The RFID scanner or smart phone transmit information over a communication link to a database/fileserver containing the most current vehicle insurance information associated with vehicle's vehicle identification number. The RFID reader or smart phone then receives information from the database/fileserver on the specific VIN queried where it is reviewed by an authorized user.

### RELATED U.S. APPLICATION DATA

Provisional application Ser. No. 13/528,916, filed on Jun. 21, 2012.

This provisional application claims the benefit, pursuant to 37 CFR 1.52, 1.121(b)(3), and 1.125 of an earlier filed U.S. provisional application. The earlier application was assigned U.S. application Ser. No. 13/527,549 filed on Jun. 19, 2012 and application Ser. No. 13/528,916 filed on Jun. 21, 2012

### STATEMENT REGARDING FEDERALLY SPONSORED RESEARCH OR DEVELOPMENT

Not Applicable

### MICROFICHE APPENDIX

Not Applicable

### BACKGROUND OF THE INVENTION

1. Field of the Invention

This invention relates to the field of vehicles. More specifically, the present invention comprises a method for providing a linking element on a vehicle which is used to obtain current vehicle insurance coverage information from a database.

2. Description of the Related Art

Car insurance is required by law, and is a law on the books in most every state. Car insurance is remains a requirement for those who cannot afford to self-insure, which is a large majority. Millions and millions of dollars are paid each year by automobile insurance companies to people injured by uninsured motorist. Someone's got to foot the bill, and it ends up being added to insured drivers' premiums. The insurance companies pass the cost on in the form of higher premiums and have to offer higher auto insurance quotes to pay for uninsured motorists' mistakes. Nationally, more than 13 percent of drivers are operating vehicles on the road without insurance. These people are 10 times more likely to get into an accident. The utility patent for the e-Sure system/method Insurance Quick Verification System will reduce if not eliminate once and for all uninsured motorist operating vehicles on our nation's roadways.

Anyone can access the 11-95 Traffic Stop website using designated service providers. Upon payment of a fee, the user may then obtain the current vehicle insurance coverage information from a database pertaining to a specific vehicle identification number. There is no existing information delivery system that provides this convenient and instant information access service. The systems can be used by persons who are in vehicles (law enforcement patrols and tow trucks), also persons on foot physically walking parking lots and other areas, and those posted in static positions (Entry points and guard shacks) who are checking the current insurance status of vehicles. Users access the site on a “smart phone” or similar device. Because the system allows for both scanning and manual entry capability of a vehicle identification number it offers a flexible use platform which is accommodating to users with disabilities.

### BRIEF SUMMARY OF THE INVENTION

This invention is designed to enhance law enforcements ability to determine if a motorist is insured or not insured during a routine traffic stop. Currently a motorist provides the police officer an insurance card that may be fake or show the policy is in force, when in fact the policy may have expired. Law enforcement has no avenue for determining if the document presented is valid.

The embodiment of this system and method is to identify the insured and uninsured motorist and eliminate fraud and falsified documents. The Quick Response code associated with the driver's insurance policy is updated daily by a service providing current policy information. The motorist that is insured and misplaced the insurance card simply displays his or her quick response code on their mobile device for scanning by the police officer and they are verified. If the motorist does not have a mobile device the law enforcement officer can scan the sticker affixed to the windshield.

The officer is equipped with a secure encrypted mobile scanning device that communicates with the service, that will return the motorist's insurance underwriter, issue date of the policy, expiration date of the policy, policy number, vehicle identification number, policy holders name, owner of the vehicle, vehicle year, vehicle make, vehicle model and insured or uninsured driver's address. For the insured motorist that has misplaced their insurance card, the capability of the officer to scan their personal quick response code prevents the motorists from the requirement of appearing in court to show proof of insurance, subsequently reducing court dockets, administration and processing of a court appearance.

Uninsured motorists have no recourse other than purchase insurance or not drive. The embodiment of this invention is to get the uninsured drivers off the roads. Insurance companies should see their customer base grow, hopefully reducing insurance cost.

### DETAILED DESCRIPTION OF THE INVENTION

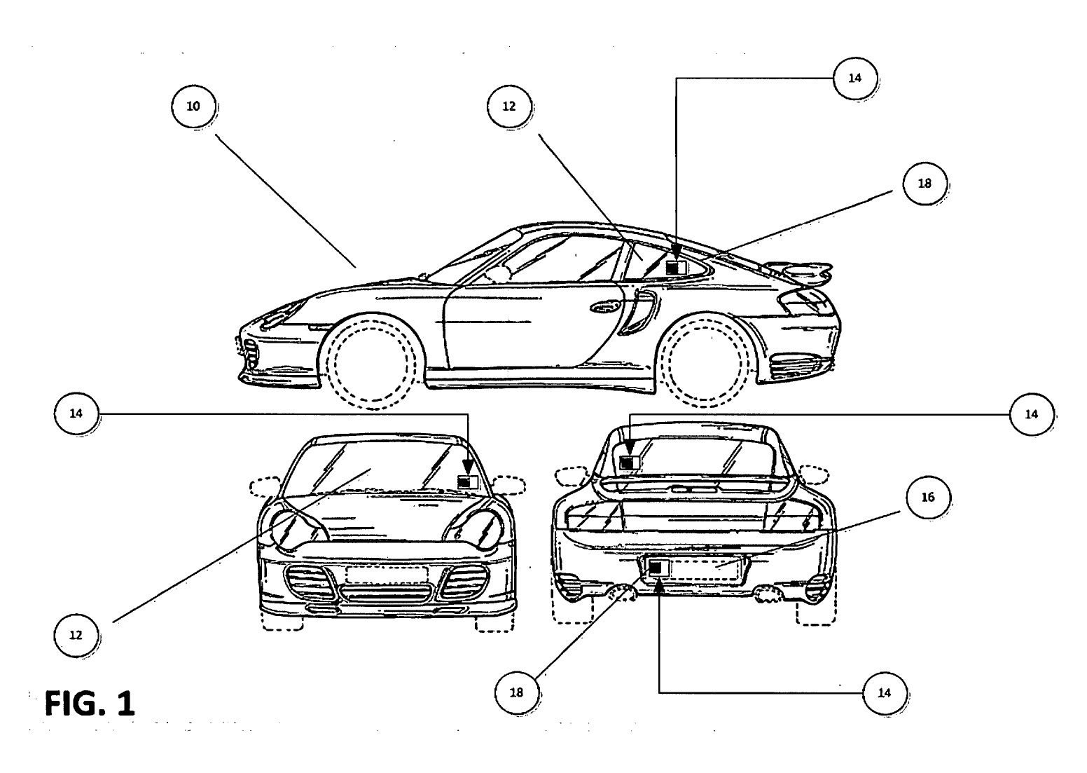

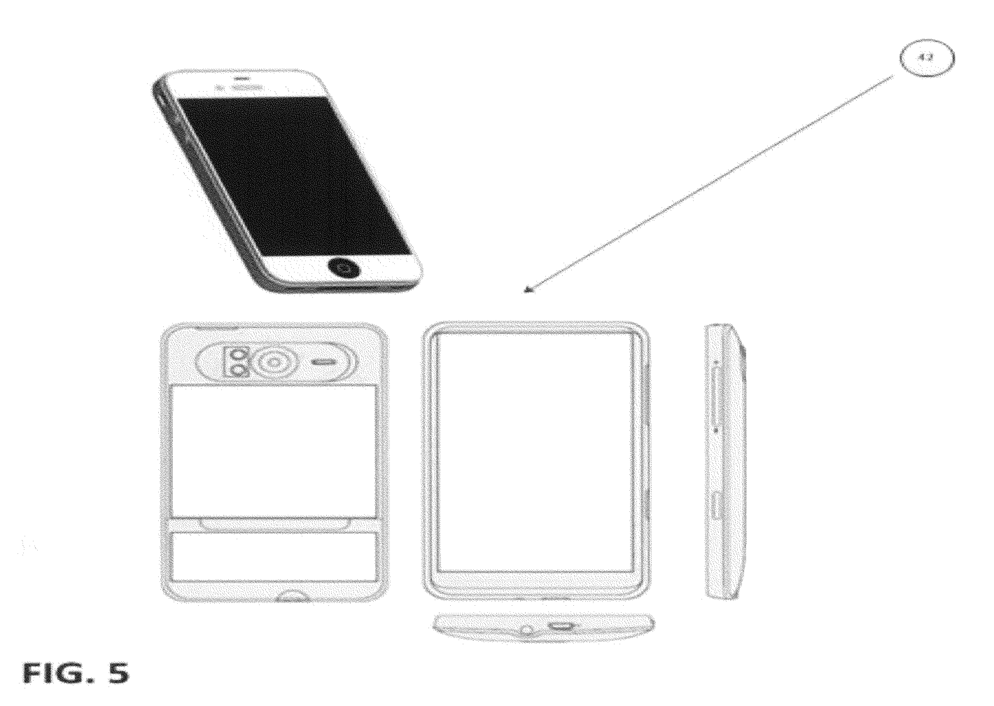

The present invention provides a FIG. 1 “linking element” 14 which is physically located on a vehicle for the purpose of insurance verification. The linking element 14 facilitates access to insurance and registration information which is specific to that vehicle 10. The linking element 14 may assume many forms. Examples include RFID tags 18 and printed Quick Response Codes (QR codes) 14. QR codes offer advantages in terms of security, the amount of information they can store, and the speed at which they can be read FIG. 5 by a device using a digital camera 42. The QR code 14 therefore represents the preferred embodiment and it will be used in the examples described hereafter.

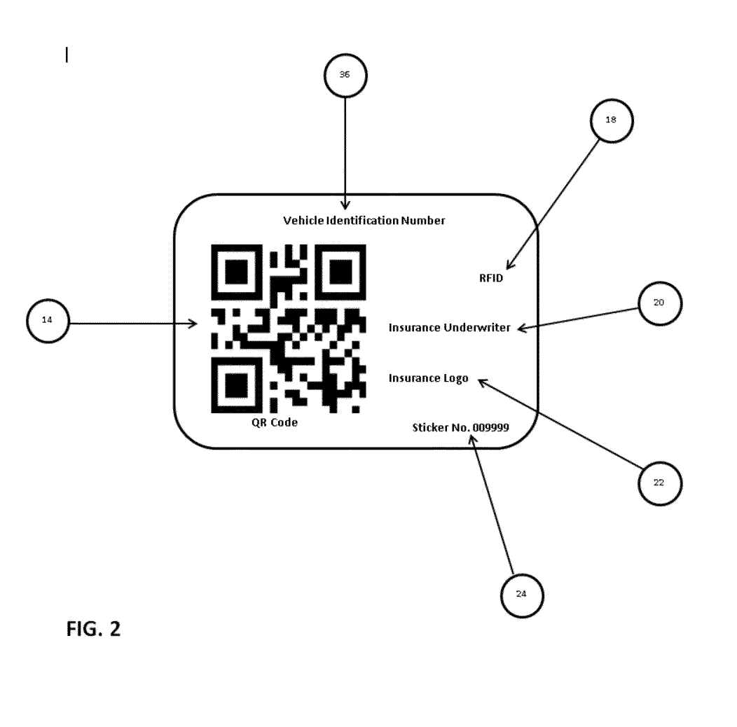

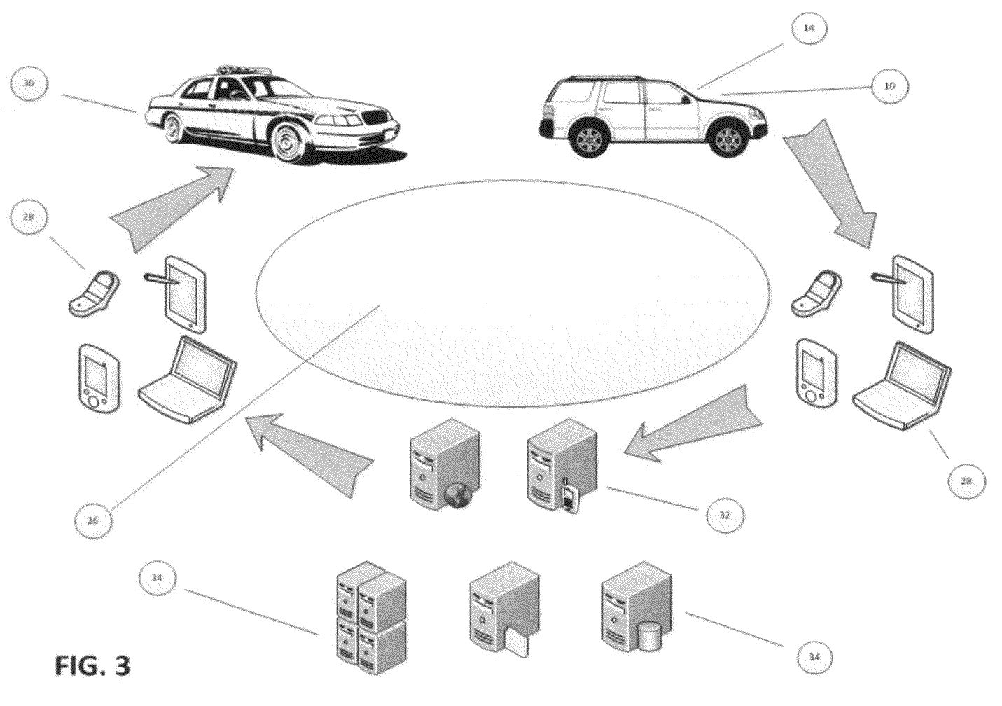

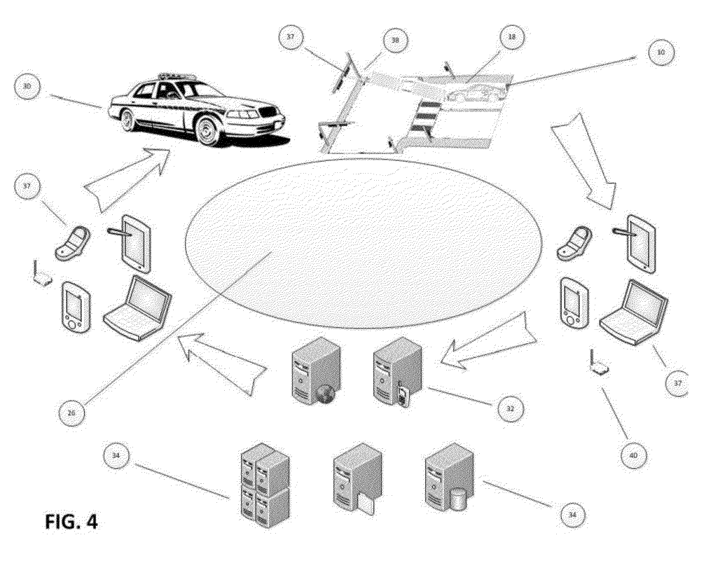

FIG. 3 shows a law enforcement vehicle 30 executing a stop on a car 10. The stop could be for violation of a traffic or vehicle safety law or as a result of a FIG. 4 fixed RFID scanning device 37 which revealed the vehicle is operating on a public road without insurance. The FIG. 2 RFID tags 18 and/or QR code 14 is affixed to the FIG. 1 vehicle 12. Under the present inventive method, it is preferable to provide a QR code 14 in a location 12 where it is visible to the authorized prospective scanner/user or fixed scanning device.

FIG. 2 shows a view of the representative RFID tag 18 and/or QR code sticker 14. The sticker includes the RFID and/or QR code preferably in a FIG. 1 prominent location 12. The user needs a FIG. 3 device 28 which can read the QR code. There are many such devices, including a dedicated QR code scanning devices. However, it is possible to use a FIG. 5 cell phone camera 42 to read a QR code and RFID scanners to receive and transmit RFID emissions.

A user can point a smart phone scanner at the RFID or QR code or a vehicle may pass by a FIG. 4 fixed RFID scanner/transmitter 37 and—assuming an appropriate software application is available on the smart phone—“capture” the RFID or QR code. FIG. 3 shows a simplified representation of scanners and smart phone 28 method of reading QR codes. The user points the smart phone or scanning device at the RFID or QR code to scan. The application running on the smart phone or scanner then interprets the information contained in the QR code or transmitted by the FIG. 4 fixed RFID reader 37. A web service (URL) accesses resources available via the Internet 32 provides the user with requested information. The smart phone or scanner then links to a database server 34 via a web service allowing the telephone's browser to retrieve insurance and or registration information about the specific vehicle.

FIG. 3 and FIG. 4 depict pictorially certain aspects of the communications taking place as the present inventive method is carried out. Communication link FIG. 3 and FIG. 4 represents any effective 26 method or methods for linking the other devices to database server 34. As one example, smart phones FIG. 5 can communicate wirelessly. The request for information from the smart phone may then be FIG. 3 transmitted over the Internet to database server 34. The database server communicates with a specific database designed to retrieve the insurance or registration information for the specific vehicle. The information is then transmitted back over the Internet and ultimately to smart phone or scanning device.

FIG. 4 shows other devices 37 which may also form a part of the process. The prospective user of the system may wish to have information displayed on a plurality of devices or sent to a separate computer which he or she designates. This feature allows the user to subsequently review the information using a larger and more convenient display than is typically found on a smart phone.

The FIG. 3 database servers 34 depicted may include a “message switch” function that links the user to one or more information databases and possibly to other functions. As an example, once the user receives the vehicle insurance coverage information on a particular vehicle, the QR code could link the user's smart phone or other computer to a State Department of Motor Vehicle website providing the user with validation information concerning FIG. 1 vehicle license plate number 16 and registration.

FIG. 2 Control numbers 24 can be associated with RFID tags and printed QR code stickers and other items featured on the linking element. Thus, an insurance underwriter or service provider are equipped with a unique source ID to control the creation of the QR codes and RFID tags. Printed QR codes will be linked to a specific vehicle and specific Insurance policy. There are many other ways to provide the printed material, 24 so the simplified depiction of FIG. 2 should properly be viewed as one example among many others.

Insurance providers may not wish to provide the RFID tags and printed QR stickers and other items featuring the linking element. In that case, the linking element can be printed by a service provider.

The QR code can be used for many additional purposes. As one example, when the owner of a vehicle applies for permanent or temporary license plates at the Department of Motor Vehicles license and registration. The DMV agent may use the QR code to verify insurance coverage for the vehicle prior to issuance of the license plates. Using the present inventive method, the DMV agent can enter the RFID or QR code registration FIG. 2 sticker number 24 into a computer and be linked to a FIG. 4 computer system 34 which will provide the vehicle insurance coverage information.

The system preferably also includes provisions whereby the user may be charged for the services requested.

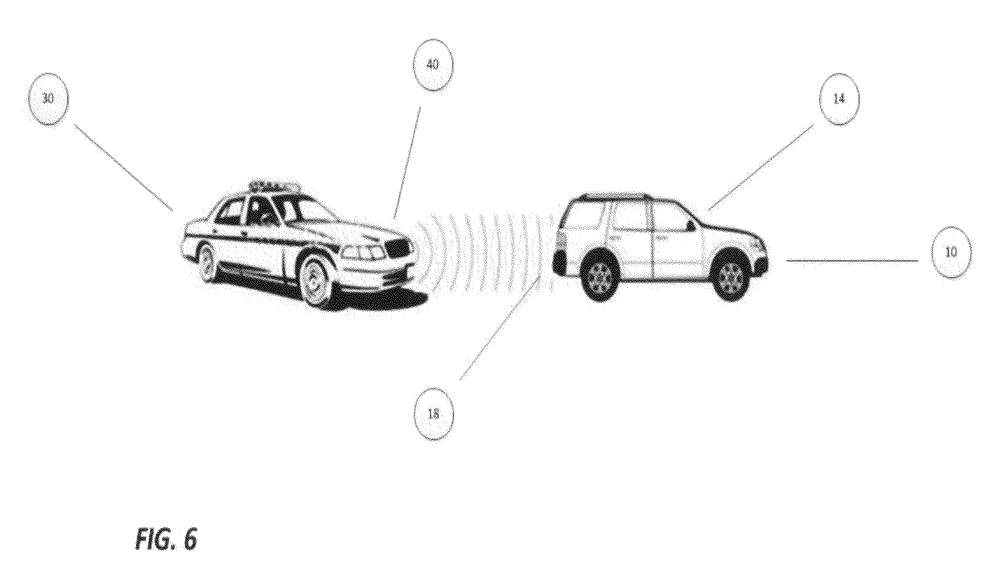

FIG. 6 shows a law enforcement vehicle 30 executing a stop on a car 10. The stop could be for violation of a traffic or vehicle safety law or as a result of a FIG. 4 fixed RFID scanning device 37 which revealed the vehicle is operating on a public road without insurance. The FIG. 6 mobile RFID reader 40 affixed to the FIG. 1 law enforcement vehicle 30 has registered an uninsured motorist. The information transmitted to the law enforcement vehicle from the motorist vehicle takes place by a proximity mobile RFID reader attached to the squad car alerting law enforcement of an uninsured vehicle. The RFID tag 18 can be issued at the time the motorist registers the vehicle at the Department of Motor Vehicles. The RFID tag can be printed on to existing license plate 16 month and year stickers or on the printed QR code sticker provided by the insurance underwriter.

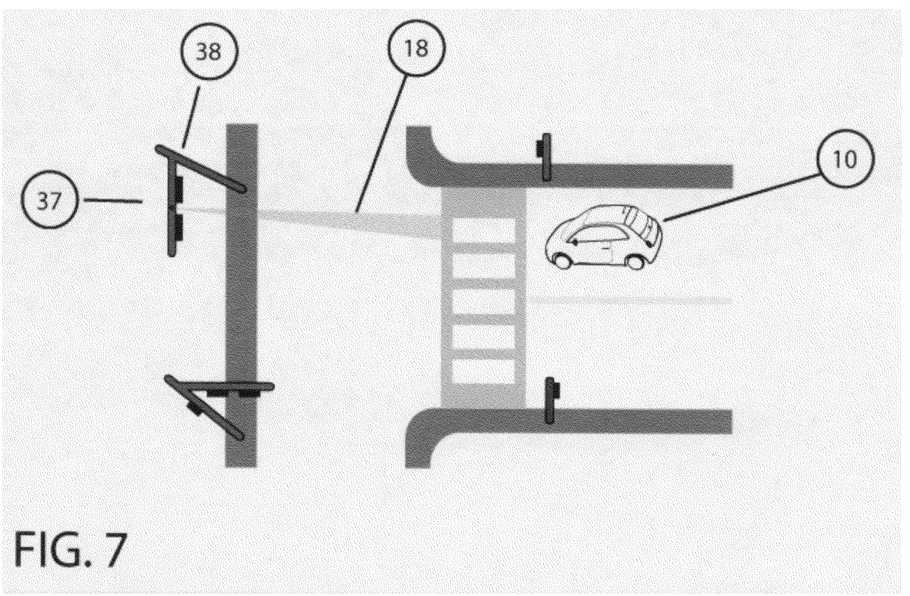

FIG. 7 shows a motorist vehicle 10 in the process of being scanned by a fixed RFID scanning device 37. The information transmitted back to the fixed RFID scanning device can alert a nearby law enforcement vehicle of the presence of an uninsured motorist. Information transmitted to law enforcement includes vehicle make, model, year, color, owner information and insurance policy status. Additionally information of the uninsured motorist can be transmitted to law enforcement whereby a subsequent summons can be issued by mail requiring the motorist to appear in court and show proof of insurance. While this is one example of a fixed RFID scanning device the embodiment of the fixed RFID scanning device can be applied in a plurality of locations, such as boat docks, state park entry and exit points, airports essentially anywhere verification or registration is required by law.

The preceding description contains significant detail regarding the novel aspects of the present invention. It should not be construed, however, as limiting the scope of the invention but rather as providing illustrations of the preferred embodiments of the invention. As an example, although RFID and QR codes have been used as the example in the embodiments disclosed in detail, other types of linking elements could be substituted. Such variations would not alter the basic functions of the invention. Thus, the scope of the invention should be fixed by specific claims, rather than by the examples given.

Having described the invention, I claim:

1. A method for providing for the specific purpose of retrieving vehicle insurance information or registration ready access for an authorized user, further comprising the steps of
a. providing a linking element physically located on said vehicle;
b. providing a scanning device to read said linking element;
c. wherein said scanning device has a communication link;
d. wherein said linking element directs said scanning device to a file server/database containing said vehicle insurance information in regard to said vehicle based upon the VIN, policy number, license information or any other identification control;
e. wherein said scanning device accesses and retrieves said information via said communication link; and
f. wherein said information is stored or displayed on said scanning device such that said authorized user can access said information.

2. The method of claim 1, wherein said linking element can be a plurality of linking elements including but not limited to RFID tag, chip, insurance card, capsule or sticker, or barcode, or a quick response code image or sticker for the specific purpose of allowing for the retrieval of car insurance information.

3. The method of claim 1, further comprising the step of providing vehicle insurance coverage information from the linking element physically located on said vehicle or insurance card via file server/database to the scanner reading device.

4. The method of claim 3, wherein said report includes said linking element and further comprises of:
a. insurance compliance information including but not limited to current level, type, registration and expiration date of insurance coverage; and
b. the insurance information and registration associated with the VIN physically located on the vehicle.

5. The method of claim 1, wherein said user scans a plurality of linking elements, including but not limited to RFID tag, chip, insurance card, capsule or sticker, or barcode, or a quick response code image or sticker for the specific purpose of retrieving car insurance information.
said user must via proximity scan, manual scan or manually enter the VIN further comprising the steps of:
a. providing a database on a file server having said data provided by automobile insurance providers to said users;
b. providing insurance company or plurality of service providers with a RFID tag, chip, insurance card, capsule or sticker, or barcode, or a quick response code image or sticker linking element;
c. wherein said scanning device reads said linking element and through said communication link accesses a file server/database containing the insurance information;
d. wherein said insurance data stored can be provided by a plurality of sources including but not limited to said insurance companies, department of motor vehicles, department of transportation to populate said database;
e. wherein said linking element accesses said file server/database containing insurance information which corresponds to said VIN, policy number, license any other identification control;
f. wherein said scanning device retrieves said information via said communication link; and
g. wherein said information is stored or displayed on said scanning device such that said user can access said information.

6. The method of claim 3, wherein said report is a scanner readout device and said linking element.

7. The method of claim 1, wherein said information is transmitted to a plurality of computing devices.

8. The method of claim 1, wherein said information is transmitted to a device capable of producing a copy of said information.

9. The method of claim 1, wherein said scanning device is a plurality of scanning devices to include but not limited to handheld scanners, stationary affixed scanners and smart phone technology.

10. A method for providing ready access to information about a current car insurance coverage and compliance associated with a VIN, policy number, license any other identification control further comprising the steps of:
a. providing through a plurality of a linking elements physically located on the body of said vehicle, wherein said a linking element stores a radio frequency identification signal, (RFID) tag, chip, insurance card, capsule or sticker, or barcode, or a quick response code image or sticker.
b. providing a scanning device having the ability to read said linking element and to be subsequently granted access to said file server/database;
c. wherein said linking element directs said scanning device through a communication link to a file server/database containing said information about said VIN's current automobile insurance coverage and compliance;
d. wherein said scanning device retrieves said information via said communication link; and
e. wherein said information is stored or displayed on said scanning device such that said user can access said information.

11. The method of claim 10, further comprising the steps of:
a. providing a compliance report corresponding to said linking element;
b. providing the identity of a plurality of insurance companies, level of coverage and coverage expiration indicators; and
c. providing an insurance coverage descriptive summary including identifying said VIN which said linking element is physically located.

12. The method of claim 10, wherein said authorized user retrieves insurance information further comprising the steps of:
a. accessing a file server/database having said data provided by and not limited to insurance companies, department of motor vehicles, department of transportation;
b. scanning a linking element;
c. wherein said linking element directs said scanning device through a communication link to database/file server containing said information about said VIN's current automobile insurance coverage and expiration and compliance;
d. wherein said scanning device retrieves level of insurance coverage and coverage expiration data via said communication link; and
e. wherein said insurance coverage and coverage expiration data is stored or displayed on said scanning device such that said user can access said information.

13. The method of claim 10, further comprising the steps of providing a vehicle manufacturer, insurance company or a plurality of service providers with said linking element.

14. The method of claim 10, wherein said information is transmitted to a plurality of computing and scanner reading devices.

15. The method of claim 10, further comprising the steps of providing linking element having said (RFID) tag, chip, insurance card, capsule or sticker, or barcode, or a quick response code image or sticker, transmission capability.

16. The method of claim 10, wherein said information is transmitted to a plurality of scanning and computing devices.

17. The method of claim 10, wherein said information is transmitted to a device capable of retrieving and displaying said retrieved information.

18. The method of claim 10, wherein said scanning device is a plurality of scanning devices and smart phone technologies.

19. The method of claim 10, wherein the communication link is designed to communicate to a backend relational database or file system and services to return registration and insurance data associated with a plurality of vehicles including but not limited to motor home, boat, jet ski, ATV, snow mobile, aircraft, and motorcycle.

20. The method of claim 10, wherein the communication link is designed to communicate to a backend relational database or file system and services to return motorist insurance data by a plurality of communication channels including but not limited to internet, Bluetooth, wireless, radio, microwave, satellite, or laser transmission.

21. The method of claim 10, wherein said user scans a plurality of linking elements, including but not limited to RFID tag, chip, insurance card, capsule or sticker, or barcode, or a quick response code image or sticker for the specific purpose of retrieving car insurance information.
Said user must via proximity scan, manual scan or manually enter the VIN further comprising the steps of:
a. providing a database on a file server having said data provided by automobile insurance providers to said users;
b. providing insurance company or plurality of service providers with a RFID tag, chip, insurance card, capsule or sticker, or barcode, or a quick response code image or sticker linking element;
c. wherein said scanning device reads said linking element and through said communication link accesses a file server/database containing the insurance information;
d. wherein said insurance data stored can be provided by a plurality of sources including but not limited to said insurance companies, department of motor vehicles, department of transportation to populate said database;
e. wherein said linking element accesses said file server/database containing insurance information which corresponds to said VIN, policy number, license any other identification control;
f. wherein said scanning device retrieves said information via said communication link; and
g. wherein said information is stored or displayed on said scanning device such that said user can access said information.

22. The method of claim 10, wherein said reader may be affixed to a stationary fixed object for the specific purpose of scanning a plurality of linking elements, including but not limited to RFID tag, chip, insurance card, capsule or sticker, or barcode, or a quick response code image or sticker for the specific purpose of retrieving car insurance information.
Stationary or fixed scanner must via proximity scan, automatically scan the VIN further comprising the steps of:
a. providing a database on a file server having said data provided by automobile insurance providers to said users;
b. providing insurance company or plurality of service providers with a RFID tag, chip, insurance card, capsule or sticker, or barcode, or a quick response code image or sticker linking element;
c. wherein said scanning device reads said linking element and through said communication link accesses a file server/database containing the insurance information;
d. wherein said insurance data stored can be provided by a plurality of sources including but not limited to said insurance companies, department of motor vehicles, department of transportation to populate said database;
e. wherein said linking element accesses said file server/database containing insurance information which corresponds to said VIN, policy number, license any other identification control;
f. wherein said scanning device retrieves said information via said communication link; and
g. wherein said information is stored or displayed on said scanning device such that said user can access said information.

23. The method of claim 10, wherein fixed or stationary support used for the attachment or mounting of scanning device includes a polarity of fixed supports to include but not limited to traffic lights, traffic and telephone poles, guard shacks and entry control points, entry gates and fences, etc.
